(19) United States
(12) Patent Application Publication
(10) Pub. No.: US 2020/0215840 A1
(43) Pub. Date: Jul. 9, 2020

(54) PRODUCT AUTHENTICITY VERIFICATION TAG, WRAPPING PAPER INCLUDING SAME, AND PRODUCT AUTHENTICITY VERIFICATION METHOD

(71) Applicant: GLOBALLINKERS CO., LTD., Seoul (KR)

(72) Inventor: Young Hae JUNG, Seoul (KR)

(21) Appl. No.: 16/632,858

(22) PCT Filed: Jun. 28, 2018
(86) PCT No.: PCT/KR2018/007321

§ 371 Date: Mar. 31, 2020

(30) Foreign Application Priority Data
Jul. 21, 2017 (KR) 10-2017-0092743

(51) Int. Cl. B42D 25/305; B42D 25/21

(52) U.S. Cl. CPC B42D 25/305; B42D 25/21

(57) ABSTRACT

Provided are an authenticity verification tag and a wrapping paper including the same. The authenticity verification tag includes a layer; a first region, which forms a border on the layer and includes identification information regarding a product to be verified for authenticity; a second region surrounded by the first region; and a plurality of spots, which are arranged in the second region and are usable for authenticity verification.

### DETAILED DESCRIPTION OF THE INVENTION

### Technical Field

The present disclosure provides a product authenticity verification tag and a wrapping paper including the same.

### PRIOR ART

Despite the recent recession, the authenticity verification market, which verifies whether a product is authentic, is growing. This is due to the increasing number of consumers who are suffering from purchasing fake products and the significant damages to property and the public image of companies producing authentic products.

For verification of authenticity, a barcode, a QR code, a hologram tag, etc. may be used. Authenticity may be verified by recognizing a tag by using a portable terminal.

In general, a quick response (QR) code is a graphic code capable of containing a large amount of information as compared to a conventional bar code, and may include not only text, pictures, and video, but also uniform resource location (URL) link information. Therefore, the number of users and fields of application are expanding.

However, since a tag like a barcode or a QR code is a flat 2D tag, it may be easily forged or altered by scanning or copying. Therefore, it is difficult to use such a tag for preventing forgery and alteration.

On the other hand, a hologram tag displays a 3-dimensional image by using the holographic principle, thus exhibiting higher security as compared to a barcode and a QR code. However, a hologram tag is less sensitive and expensive. Also, a general portable terminal may not be used as a reader for a hologram tag.

There is a need for a tag that may not be easily forged or altered and may be read by using a portable terminal equipped with a camera.

### DISCLOSURE OF THE INVENTION

### Technical Goal of the Invention

The present disclosure provides a tag that may be recognized by using an application of a mobile terminal and a wrapping paper including the tag.

The present disclosure provides a method of verifying authenticity from the tag and a system therefor.

### Means for Achieving Technical Goal

An authenticity verification tag according to an embodiment includes: a layer; a first region, which forms a border on the layer and includes identification information regarding a product to be verified for authenticity; a second region surrounded by the first region; and a plurality of spots, which are arranged in the second region and are usable for authenticity verification.

In addition, the plurality of spots may be spaced apart from one another.

Also, each of the plurality of spots may be any one of special characters, letters, and numbers.

In addition, at least one of sizes, shapes, arrangement directions, and colors of the spots adjacent to one another from among the plurality of spots may differ.

Also, at least one of the plurality of spots may have a thickness of 0.02 mm or less.

In addition, at least one of the plurality of spots may have a length of 0.10 mm or less.

Also, the plurality of spots may include authentication elements used for the authenticity verification and camouflage elements not related to the authenticity verification.

In addition, at least one of a location in the second region, a density, a color, and a shape of the authentication element is pre-defined.

Also, the authentication element may include a separate color.

In addition, a plurality of copy-proof elements, which are arranged in the second region and indicate that the authenticity verification tag is fabricated in a manner different from a pre-defined manner,

Also, at least one of sizes, shapes, arrangement directions, and colors of the copy-proof elements adjacent to one another from among the plurality of copy-proof element may be the same.

In addition, the plurality of copy-proof elements may be larger in size than the plurality of spots.

Also, the interval between the plurality of copy-proof elements may be smaller than the interval between the plurality of spots.

In addition, the first region may be 1-dimensionally arranged in first unit elements having a first color and second unit elements having a second color different from the first color.

Also, the identification information may be indicated by a combination of first unit elements and second unit elements that are arranged at a certain distance from the first unit element.

In addition, the identification information may include at least one of information regarding a manufacturer providing the product, brand information regarding the product, and detailed information regarding the product.

Also, the second region may include at least one of an image and text related to the product.

In addition, at least one of the image and the text may be disposed to overlap the spots.

Also, at least one of the image and the text may be larger than sizes of the spots.

A method of verifying authenticity by using a tag includes: obtaining identification information regarding a product from a first region of the tag; obtaining information regarding an authentication element corresponding to identification information, by using metadata; verifying whether the authentication element exists in the second region of the tag, by using the information regarding an authentication element; and outputting a result of the verification.

In addition, the first area may be a border of the tag.

Also, the second region may be surrounded by the first region.

In addition, the authentication element may be arranged in a spot shape on the second area.

Also, the information regarding an authentication element may include at least one of a shape, a size, a color, a location in the second region of the authentication element.

In addition, the identification information may be obtained by converting first unit elements having a first color included in the first region and second unit elements having a second color different from the first color into a binary representation.

Also, the metadata may include: a plurality of pieces of identification information; and information regarding a plurality of authentication elements corresponding to each of the plurality of pieces of identification information.

In addition, photographing the tag may be further included.

Also, the result of the verification may output a first indicator indicating that the authentication element is authentic when the authentication element exists in the second region, and may output an indicator indicating that the authentication element is not authentic when the authentication element exists in the second region.

In addition, transmitting the result of the verification to a management server managing the tag may be further included.

Also, the management server may further include matching location information of a device outputting the result of the verification to the result of the verification and then storing results.

In addition, the management server may further include transmitting the metadata and an application for authenticity verification to the device outputting the result.

On the other hand, a system according to an embodiment includes: a user terminal for verifying authenticity from a tag; and a management server for providing an application for verifying the authenticity to the user terminal, and the user terminal obtains identification information about a product from a first region that is a border of the tag by using the application and verifies authenticity by verifying whether an authentication element exists in a second region of the tag surrounded by the second region by using the application.

### BRIEF DESCRIPTION OF THE DRAWINGS

FIG. 1 is a diagram showing an authenticity verification tag according to an embodiment.

FIG. 2 is an enlarged view of a first region of the tag of FIG. 1.

FIG. 3 is an enlarged view of some spots included in the tag of FIG. 1.

FIG. 4 is a diagram showing an authenticity verification tag according to another embodiment.

FIG. 5 is a reference diagram showing an authenticity verification tag printed at different resolutions.

FIG. 6 is a diagram showing an authenticity verification tag according to another embodiment.

FIG. 7 is a diagram showing a wrapping paper in which an authenticity verification tag according to an embodiment is integrated.

FIGS. 8 through 10 are diagrams showing examples of various types of first regions.

FIGS. 11 through 13 are diagrams showing examples of various types of spots.

FIG. 14 is a block diagram showing a system for verifying authenticity by using a tag according to an embodiment.

FIG. 15 is a block diagram showing a management server of FIG. 14.

FIG. 16 is a block diagram showing a user terminal of FIG. 14.

FIG. 17 is a flowchart of a method by which a user terminal performs authenticity verification, according to an embodiment.

FIG. 18 is a diagram showing an example of outputting a first indicator according to an embodiment.

FIG. 19 is a reference diagram showing examples of identification information and an authentication element according to an embodiment.

FIG. 20 is a diagram showing an example of outputting a second indicator, according to an embodiment.

FIG. 21 is a reference diagram showing an example of a third indicator indicating that a tag is authentic, according to an embodiment.

FIG. 22 is a reference diagram showing an example of a fourth indicator indicating that a tag is not authentic according to an embodiment.

### DESCRIPTION OF EMBODIMENT

Hereinafter, detailed descriptions of the present disclosure will be given with reference to the accompanying drawings. In the drawings, like reference numerals denote like elements, and the size of each component in the drawings may be exaggerated for clarity and convenience of explanation.

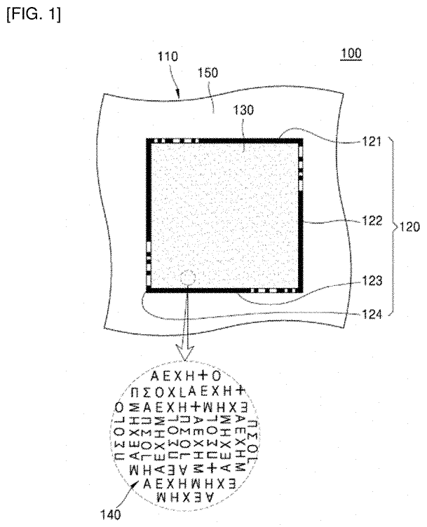

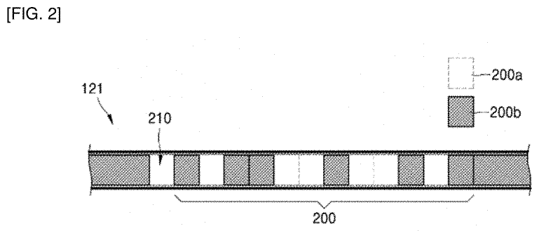

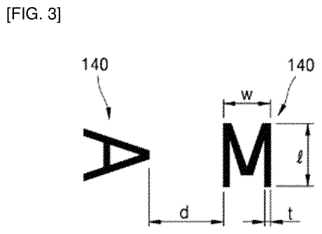

FIG. 1 is a diagram showing a product authenticity verification tag according to an embodiment, FIG. 2 is an enlarged view of a first region 120 of the tag of FIG. 1, and FIG. 3 is an enlarged view of some of spots 140 included in the tag of FIG. 1.

Referring to FIGS. 1 to 3, a tag (hereinafter referred to as a ‘authenticity verification tag’) 100 according to an embodiment may include a layer 110, a first region 120 that forms the border of the tag on the layer 110 and includes identification information regarding a product for authenticity verification, a second region 130 surrounded by the first region 120, and a plurality of spots 140 that are arranged in the second region 130 and may be used for authenticity verification.

The layer 110 may include a transparent material or a translucent material and may include a material on which the first region 120 and the second region 130 may be printed. As will be described below, the layer 110 may be a partial layer of a wrapping paper 710 for wrapping a product.

For example, the layer 110 may include polyethylene phthalate (PET). PET exhibits high tensile strength, excellent thermal stability and dimensional stability, and no cosmetic change even under conditions causing softening and shrinkage due to heat, and thus shrinkage rate of PET is small when printed. The material constituting the layer 110 is not limited to PET. The layer 110 may include at least one material from among oriented polypropylene (OPP), oriented nylon (ONY), and nylon (NY). The material constituting the layer 110 may be determined according to the type of a product to be wrapped.

The layer 110 may include a material that may be attached to and detached from other materials. For example, the layer 110 may include at least one from among benzene, trichloroethylene (TCE), formaldehyde, lead, nickel, cadmium, chromium, sulfuric acid, ethylene oxide, dimethylformamide (DMF), TDI (toluene-2,4-di Isocyanate/toluene-2,6-diisocyanate), normal hexane, methylene chloride (MC), methanol (methyl alcohol), toluene, styrene, hydrochloric acid (hydrogen chloride), hydrofluoric acid (hydrogen fluoride), mercury, tetramethylammonium hydroxide (TMAH), phenol, methyl bromide, and chloroform (trichloromethane).

The first region 120 forming the border of the authenticity verification tag 100 and the second region 130 surrounded by the first region 120 may be arranged on the layer 110. Also, the layer 110 may include a peripheral region 150 other than the first region 120 and the second region 130.

The first region 120 may have a frame-like shape to partition the second region 130 from the peripheral region 150. As shown in FIG. 1, the first region 120 may have a rectangular shape. However, the present disclosure is not limited thereto. The first region 120 may be any shape capable of partitioning the second region 130 from the peripheral region 150. For example, the first region 120 may have a polygonal shape, such as a triangular shape or a pentagonal shape, other than a rectangular shape or may have a circular shape or an elliptical shape.

The first region 120 may include a plurality of sub-regions 121. The first region 120 may include first to fourth sub-regions 121, 122, 123, and 124. Every two of four sub-regions 121, 122, 123, and 124 may have the same shape. For example, a first sub-region 121 and a third sub-region 123 may be rotationally symmetrical with each other about the center of the authenticity verification tag 100, and a second sub-region 122 and a fourth sub-region 124 may also be rotationally symmetrical with each other around the center of the authenticity verification tag 100. However, the present disclosure is not limited thereto. The first sub-region 121 and the second sub-region 122 may be rotationally symmetrical with each other, and the third sub-region 123 and the fourth sub-region 124 may be rotationally symmetrical with each other.

As shown in FIG. 2, the first region 120 may be formed by 1-dimensionally arranging first unit elements 200a having a first color and second unit elements 200b having a second color different from the first color. The first color may be white and the second color may be black, but are not limited thereto. The first color and the second color may be different colors that may be identified. Here, identification of colors here may be visual identification or identification through a computer. Also, the first unit element 200a and the second unit element 200b may have the same length l. Therefore, the length l of the first unit element 200a and the second unit element 200b may be referred to as a unit length l.

The first region 120 may include identification information of a product for authenticity verification through a combination of the first unit elements 200a and the second unit elements 200b. Here, the identification information may include at least one of information regarding a manufacturer that manufactures the product, brand information of the product, and detailed information regarding the product (e.g., function, product name, etc.).

Identification information 200 as described above may be included in at least one of the first to fourth sub-regions 121, 122, 123, and 124. FIG. 1 shows that the identification information 200 is displayed in each of the first to fourth sub-regions 121, 122, 123, and 124. However, the present disclosure is not limited thereto.

As described above, the fact that the first sub-region 121 and the third sub-region 123 are rotationally symmetrical with each other, and the second sub-region 122 and the fourth sub-region 124 are rotationally symmetrical with each other may indicate that the same first identification information is included in the first sub-region 121 and the third sub-region 123 and the same second identification information is included in the second sub-region 122 and the fourth sub-region 124. In this regard, two or more of the same identification information is displayed, such that, when one identification information is not recognized due to damage, the other identification information may be used.

The identification information 200 may be encoded as a combination of the first unit elements 200a and the second unit elements 200b of the first region 120. For example, when a point at which the first unit element 200a is displayed based on a first end of the first sub-region 121 is referred to as a starting point 210 of the identification information 200, the first unit elements 200a and the second unit elements 200b arranged from the starting point 210 for a certain distance in a direction from the first end to a second end of the first sub-region 121 (e.g., the rightward direction) may become the identification information 200. When the certain distance is 12 unit lengths l, first to twelfth unit elements from the starting point 210 may be identification information 200. For example, when the first unit element 200a is ‘0’ and the second unit element 200b is ‘1’, the identification information 200 as shown in FIG. 2 may be ‘101100100101’. A reader, such as a portable terminal, may recognize such an encoded identification information 200 more easily.

The space surrounded by the first region 120 may be referred to as the second region 130. The second region 130 may be printed in a different color from the first region 120. In other words, the background color of the second region 130 may include a third color different from the first color and the second color.

Meanwhile, the plurality of spots 140 that may be used for authenticity verification may be disposed in the second region 130. Although the spots 140 are arranged in the second region 130, the size of the spots 140 may be too small for visually identification. As shown in FIG. 1, when the spots 140 are enlarged, the plurality of spots 140 may be spaced apart from one another. Each of the spots 140 may be any one of special characters, letters, and numbers. FIG. 1 shows that the spots 140 are English letters. However, the present disclosure is not limited thereto, and the letters may be those of the other types of languages, such as Korean, Japanese, and Chinese, as well as special characters, numbers, etc.

The size of each spots 140 may be a visually unrecognizable size. For example, as shown in FIG. 3, the spots 140 may have a thickness t of about 0.02 mm or less. Alternatively, the spots 140 may have a length l of about 0.10 mm or less, and the spots 140 may also have a width w of about 0.10 mm or less. The interval between the spots 140 may be about 0.15 mm or less.

Meanwhile, at least one of sizes, shapes, arrangement directions, and colors of the spots 140 adjacent to one another from among the plurality of spots 140 may differ. As the spots 140 of different types are randomly arranged as described above, the spots 140 may not be visually identified, but the spots 140 may be visually seen as being separated from one another. Also, since the spots 140 are arranged throughout the second region 130 and are randomly arranged, replication of the authenticity verification tag 100 according to an embodiment may be difficult.

The spots 140 may also be used for authenticity verification. For example, the spots 140 may be divided into authentication elements used for authenticity verification and camouflage elements not related to authenticity verification. Spots corresponding to authentication elements and spots corresponding to camouflage elements may be pre-defined. In other words, at least one of a location in the second region 130, a density, a color, and a shape of the authentication element may be pre-defined. For example, the authentication element may include a separate color to be distinguished from the camouflage element, and the camouflage element may include a combination of basic colors. However, the present disclosure is not limited thereto. The authentication element, like the camouflage element, may include a combination of basic colors.

A reader (e.g., a user terminal) may verify authenticity by recognizing information regarding an authentication element corresponding to identification information (i.e., a location in the second region 130, a density, a color, and a shape of the authentication element) by using metadata and recognizing whether the authentication element exists in the second region 130. A method by which a reader checks the authentication element will be described below.

The first region 120, the second region 130, and the spots 140 as described above may be printed on the layer 110 by using a precision printing technique.

In the authenticity verification tag 100 according to an embodiment, identification information regarding a product is distinguished from an authentication element used to verify authenticity thereof. Also, since the authentication element is not only mixed with many camouflage elements, it is also difficult to visually distinguish the camouflage elements from the authentication element with a tag only, and thus it is difficult to replicate the authenticity verification tag 100. Also, since the metadata to which an authentication element and identification information are matched is stored in a device other than the authenticity verification tag 100, security of information for authenticity verification may be doubled.

Also, since the authenticity verification tag 100 according to an embodiment may be directly printed on the wrapping paper 710 for packaging a product or printed on the product, the authenticity verification tag 100 may increase reliability of the product. In other words, when the authenticity verification tag 100 is authentic, a product related to the authenticity verification tag 100 may more likely be authentic.

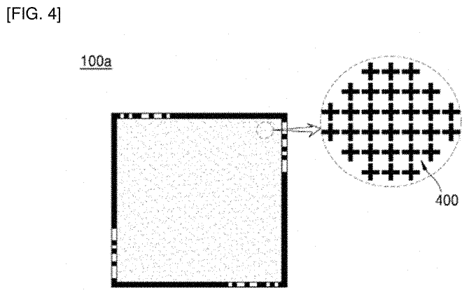

FIG. 4 is a diagram showing an authenticity verification tag according to another embodiment. Compared to that of FIG. 1, the authenticity verification tag of FIG. 4 may include a plurality of copy-proof elements 400 in the second region 130. The copy-proof elements 400 may indicate that the copy-proof elements 400 are manufactured in a manner different from the pre-defined manner. The copy-proof element may be larger than the spots 140. For example, the copy-proof element may have a thickness, a length, and a width that are about 1.5 times or larger than those of the spots 140. Also, the interval between the copy-proof elements 400 may be smaller than the interval between the plurality of spots 140.

At least one of sizes, shapes, arrangement directions, and colors of the copy-proof elements 400 adjacent to one another from among the plurality of copy-proof element 400 may be the same. Although FIG. 4 shows that the copy-proof elements 400 have a cross-like shape, but the present disclosure is not limited thereto. The copy-proof element 400 may also have shapes like special characters, letters, and geometric shapes other than the cross-like shape. The plurality of copy-proof elements 400 may be arranged at edges of the second region 130, but the present disclosure is not limited thereto.

When the authenticity verification tag 100 is replicated in a copying method with a resolution lower than a precise printing method used for fabricating the authenticity verification tag 100, the copy-proof elements 400 may be printed in a plane shape instead of spots.

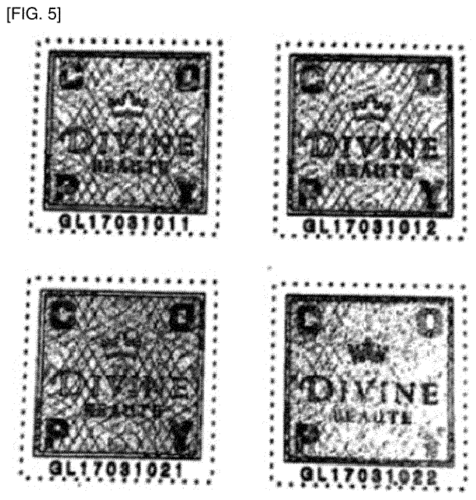

FIG. 5 is a reference diagram showing an authenticity verification tag printed at different resolutions. When an authenticity verification tag is printed by using a machine with a resolution lower than a pre-defined resolution, as shown in FIG. 5, at least some of copy-proof elements are smeared, and thus particular letters (e.g., ‘COPY’) may appear. When an authenticity verification tag is replicated by a copier with a resolution lower than the pre-defined resolution, not only the copy-proof elements, but also spots are smeared to some extent. However, since the copy-proof elements are larger than the spots and the interval between the copy-proof elements is smaller than the interval between spots, a region in which the copy-proof elements are arranged is printed in a plane shape, and thus a user may recognize the copy-proof elements as particular letters.

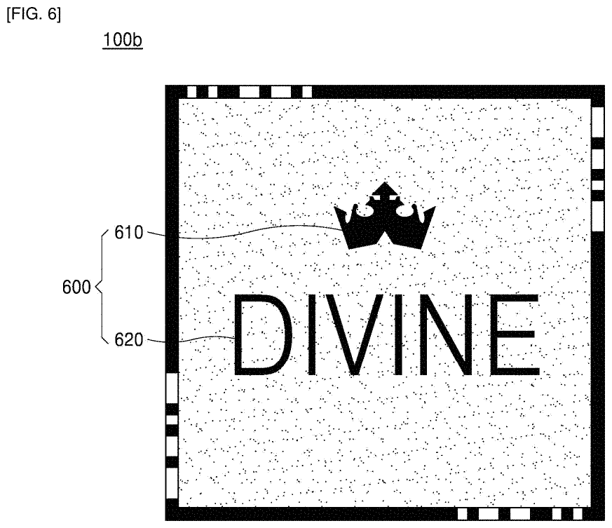

FIG. 6 is a diagram showing an authenticity verification tag according to another embodiment. As shown in FIG. 6, information regarding a product may be placed in the second region 130 of an authenticity verification tag. Information 600 regarding the product may display at least one of an image 610 and a letter 620. The image 610 and the letter 620 may be a product name, a brand of a product, a picture of a model advertising the product, a name of a manufacturer of the product, a logo, etc. The image 610 or the letter 620 may be provided to overlap the spots 140 of the second region 130. Also, the image 610 or the letter 620 may be significantly larger than the spots 140. For example, the size of the image 610 or the letter 620 may be about 100 times the size of a camouflage element. As described above, since the information regarding a product is displayed in the second region 130, the authenticity verification tag not only functions as an authenticity verification tag, but also exposes information regarding the product while a user is photographing the tag or is watching a wrapping paper. Therefore, advertisement effect may be expected.

According to an embodiment, the layer 110 of the authenticity verification tag 100 may be a sticker type. Therefore, the layer 110 may be attached to and detached from the wrapping paper 710 for wrapping a product. However, the present disclosure is not limited thereto. The layer 110 of the authenticity verification tag 100 may be a part of a wrapping paper.

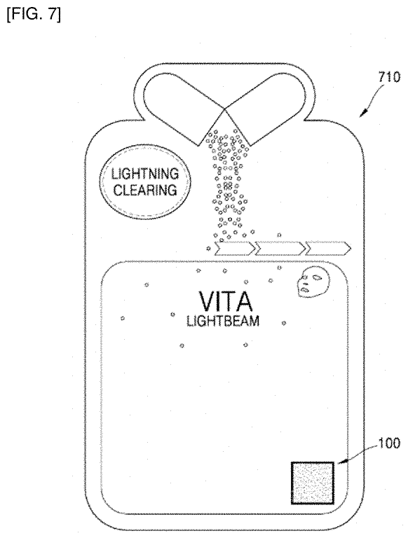

FIG. 7 is a diagram showing the wrapping paper 710 integrated with the authenticity verification tag 100 according to an embodiment. As shown in FIG. 7, the authenticity verification tag 100 may be printed with an image of the wrapping paper 710 as a part of the wrapping paper 710 of a product. In other words, the authenticity verification tag 100 may be manufactured integrally with the wrapping paper 710. Also, the authenticity verification tag 100 may be coated once more together with the wrapping paper 710, and thus the authenticity verification tag 100 may be safely handled.

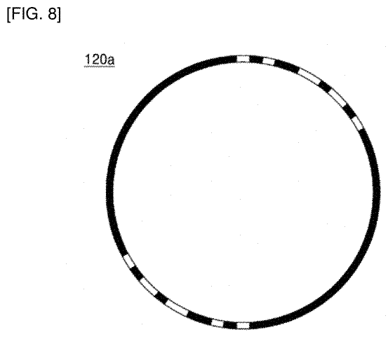

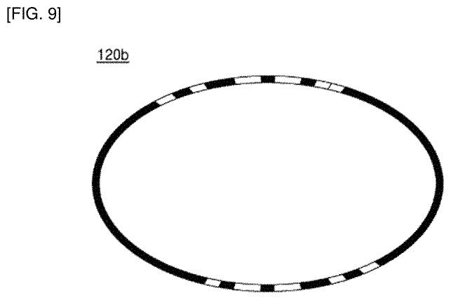

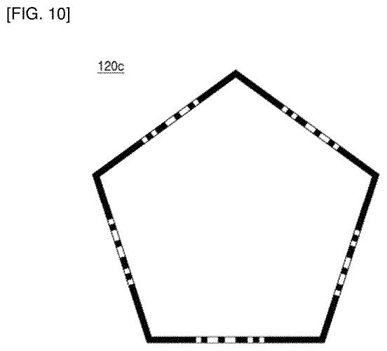

FIGS. 8 through 10 show examples of various types of first regions 120a, 120b, and 120c. As shown in FIG. 8, a first region 120a may have a circular shape. As shown in FIG. 9, a first region 120b may have an elliptical shape. Alternatively, as shown in FIG. 10, a first region 120c may have a pentagonal shape. The shape of the first region 120 may vary, and the first region 120 may include a binary arrangement of first unit elements and second unit elements. Also, a combination of the first unit elements and the second unit elements after a first unit element is initially provided may become identification information regarding a product. The identification information may be binary coded. In addition to the shapes of the first region 120 shown above, the first region 120 may have various other shapes.

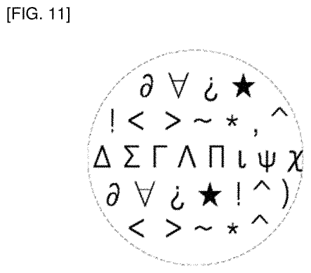

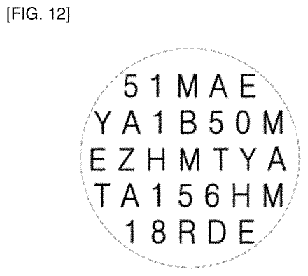

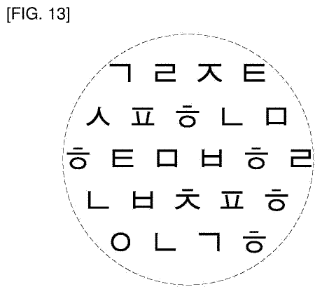

FIGS. 11 through 13 show examples of various types of the spots 140. As shown in FIG. 11, the spots 140 may be special characters. Alternatively, as shown in FIG. 12, a combination of English alphabet letters and numbers may be used. Alternatively, as shown in FIG. 13, the spots 140 may be Hangul letters. Some of the spots 140 may become authentication elements and the remaining spots 140 may become camouflage elements. Spots serving as the authentication elements may be pre-defined by an administrator managing the authenticity verification tag 100 described above. Also, information regarding camouflage elements may vary according to identification information regarding products.

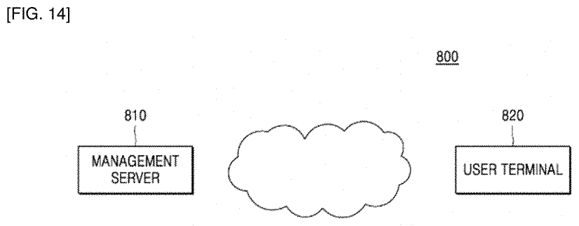

FIG. 14 is a block diagram showing a system 800 for verifying authenticity by using a tag according to an embodiment. As shown in FIG. 14, the system 800 includes a management server 810 that provides an application for authenticity verification (hereinafter referred to as an “authenticity verification application”.) and a user terminal 820 that receives the authenticity verification application from the management server 810 through a network and verifies authenticity by using a tag. Here, the tag is a tag having a two-dimensional shape and may include the authenticity verification tag 100 described above. It may be determined whether the tag is authentic based on identification information and authentication elements in the tag. When the tag includes pre-registered identification information and authentication elements, it may be determined that the tag is authentic, and a product associated with the tag may also be determined as an authentic product.

The network may be implemented in any type of wired/wireless networks, such as a local area network (LAN), a wide area network (WAN), a value added network (VAN), a personal local area network (PAN), a mobile radio communication, or a satellite communication network.

The management server 810 is a device that may be connected to the user terminal 820 to transmit and receive data and is capable of providing an authenticity verification application per a user request. When the user terminal 820 connects to the management server 810 via a network, the management server 810 may provide the user terminal 820 with various screens for providing an authenticity verification application. An authenticity verification application may include information regarding authentication elements according to identification information.

The management server 810 may update the application for authenticity verification from time to time to the user terminal 820, which has downloaded the application for authenticity verification and may receive not only a result of authenticity verification, but also location information and time information regarding the user terminal 820 during the authenticity verification from the user terminal 820. Also, the management server 810 may obtain data related to authenticity verification, e.g., a frequency for authenticity verification, a location of authenticity verification, a time zone of authenticity verification, and information regarding a user who performed authenticity verification, by using information received from the user terminal 820, e.g., a result of authenticity verification, location information, and time information.

The user terminal 820 is a terminal that may be used by a user and is a terminal capable of transmitting and receiving data by accessing the management server 810 through a wired or wireless network. The user terminal 820 may be a terminal including a camera 1040 capable of photographing a tag. The user terminal 820 may be a smart phone, a PC, a tablet PC, a notebook, a smart TV, a mobile phone, a personal digital assistant (PDA), a laptop computer, a media player 110, a micro server, a global positioning system (GPS) device, an e-book terminal, a digital broadcasting terminal, a navigation device, a digital camera 1040, a wearable device, and other mobile or non-mobile computing devices, but the present disclosure is not limited thereto.

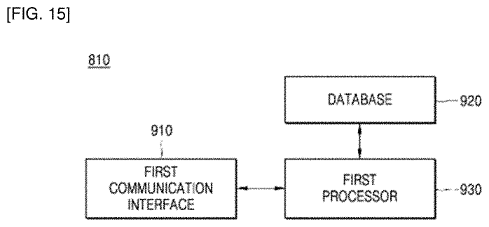

FIG. 15 is a block diagram showing the management server 810 of FIG. 14.

Referring to FIG. 15, the management server 810 may include a first communication interface 910 that communicates with an external device (e.g., the user terminal 820) via a network, a database 920 that stores and manages various data like an authenticity verification application, and a first processor 930, which provides the authenticity verification application stored in the database 920 to the user terminal 820 through the first communication interface 910 per request of the user terminal 820 and receives a result of authenticity verification from the user terminal 820 and stores the same in the database 920.

In addition to the authenticity verification application, identification information and information regarding authentication elements according to products or manufacturers may be stored in the database 920 in the form of metadata. For example, when there is a request of a customer, an administrator may specify identification information and information regarding authentication elements and fabricate the authenticity verification tag 100 as described above. Also, the administrator may input the identification information and the information regarding the authentication elements through a user interface (not shown) of the management server 810. Then, the first processor 930 may store the identification information and the information regarding authentication elements in the database 920 in the form of metadata.

The first processor 930 may provide metadata and an authenticity verification application stored in the database 920 to the user terminal 820 according to a request of the user terminal 820, and, when a result of authenticity verification is received from the user terminal 820, the first processor 930 may store information about the result of authenticity verification in the database 920. The first processor 930 may generate various data useful to a customer based on a result of authenticity verification, e.g., a fake tag location, an authentic product distribution channel, etc.

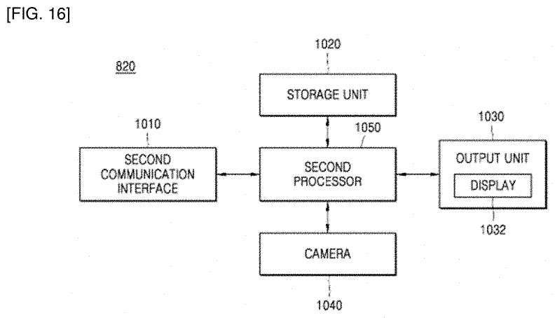

FIG. 16 is a block diagram showing the user terminal 820 of FIG. 14. The user terminal 820 is a terminal for a user to verify authenticity from a tag by executing an authenticity verification application.

As shown in FIG. 16, the user terminal 820 may include a second communication interface 1010 that communicates with an external device (e.g., the management server 810), a storage unit 1020 in which data related to an authenticity verification application, identification information, information regarding authentication elements are stored, an output unit 1030 that outputs a result of authenticity verification, a camera 1040 that photographs a tag, and a second processor 1050 that controls the overall functions of the user terminal 820. The user may access the management server 810 through the user terminal 820 and download the authenticity verification application. Next, the user may perform authenticity verification by using the above application. The output unit 1030 that outputs a result of authenticity verification may be a display. However, the present disclosure is not limited thereto and may be implemented as a speaker.

The user terminal 820 may be implemented with one housing or may be implemented with a plurality of housings. When the user terminal 820 is implemented with a plurality of housings, a plurality of components may be connected to one another via a wire or wirelessly. For example, the user terminal 820 may be divided into a first device including the camera 1040 and a second device including the storage unit 1020, the output unit 1030, and the second processor 1050.

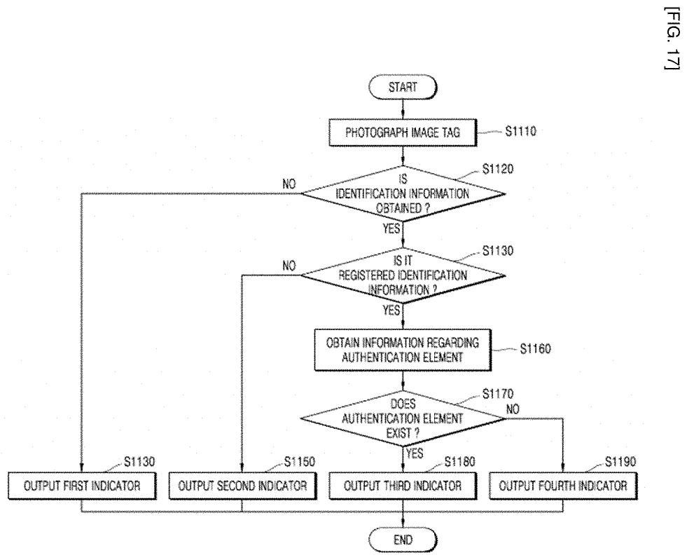

FIG. 17 is a flowchart of a method by which the user terminal 820 performs authenticity verification according to an embodiment. Referring to FIG. 17, the user terminal 820 may photograph a tag (operation S1110). For example, a user may set the mode of the user terminal 820 to an authenticity verification mode. When the user accesses the management server 810 through the user terminal 820 and downloads an authenticity verification application, the user terminal 820 may display an icon related to the application on a display. When a user input for selecting the icon is received, the second processor 1050 may set the mode of the user terminal 820 to the authenticity verification mode and execute the authenticity verification application. Next, the second processor 1050 may activate the camera 1040. The user may position the camera 1040 to face the tag, and the second processor 1050 may photograph the tag.

The second processor 1050 may determine whether identification information is obtained from the tag (operation S1120). In addition to the authenticity verification tag 100 according to an embodiment, the tag may further include a bar code, a QR code, and other tags having a similar shape to the authenticity verification tag 100.

Meanwhile, as shown in FIG. 1, the authenticity verification tag 100 as a tag according to an embodiment includes: a first region 120 including identification information regarding a product that is to be verified for authenticity; a second region 130 that is a space within the first region 120 and includes an authentication element for authenticity verification and a camouflage element not related to the authenticity verification. The first region 120 may have a frame-like shape to partition the second region 130 from the peripheral region 150. The first region 120 may have a rectangular shape. However, the present disclosure is not limited thereto. For example, the first region 120 may have a polygonal shape, such as a triangular shape or a pentagonal shape, other than a rectangular shape or may have a circular shape or an elliptical shape, as long as the first region 120 may partition the second region 130 from the peripheral region 150.

The first region 120 may be formed by 1-dimensionally arranging first unit elements 200a having a first color and second unit elements 200b having a second color different from the first color. The first color may be white and the second color may be black, but are not limited thereto. The first color and the second color may be different colors that may be identified. Identification information regarding a product may be displayed by a combination of the first unit elements 200a and the second unit elements 200b. Here, the identification information may include at least one of information regarding a manufacturer that manufactures the product, brand information of the product, and detailed information regarding the product (e.g., function, product name, etc.). Therefore, the second processor 1050 may obtain identification information by recognizing the first unit elements 200a and the second unit elements 200b that are binarily arranged and included in the first region 120.

For example, as shown in FIG. 1, the first region 120 may be divided into first to fourth sub-regions 121, 122, 123, and 124. When a point at which the first unit element 200a is shown at a first end of the first sub-region 121 is referred to as a starting point 210 of the identification information 200, the second processor 1050 may recognize first unit elements 200a and second unit elements 200b arranged for a certain distance from the starting point 210 in a direction from the first end toward a second end of the first sub-region 121 (e.g., the rightward direction) as the identification information 200. For example, when the certain distance is 12 unit lengths, the first unit element 200a is ‘0’, and the second unit element 200b is ‘1’, the second processor 1050 may obtain the identification information 200 of ‘101100100101’ from the first sub-region 121.

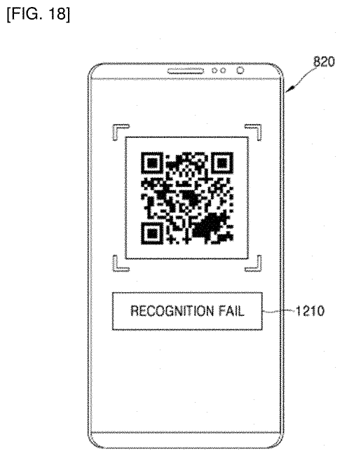

On the other hand, when it is unable to obtain identification information from the tag (operation S1120—No), the second processor 1050 may output a first indicator indicating that the tag is not recognized through the output unit 1030 (operation S1130). The tag may not be the authenticity verification tag 100 according to an embodiment, and may be a bar code or a QR code. In other words, the first region 120 may not exist in the tag, or, even when the first region 120 exists, the first unit elements 200a and the second unit elements 200b may not exist. In such a case, the second processor 1050 is unable to obtain identification information from the tag. In this case, the user terminal 820 may output the first indicator indicating that the tag is not recognized. FIG. 18 is a diagram showing an example of outputting a first indicator 1210 according to an embodiment. As shown in FIG. 18, the first indicator 1210 may be displayed as a text on a display.

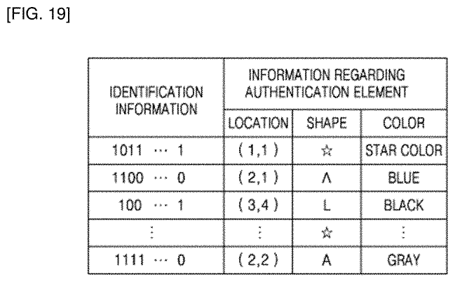

When identification information is obtained (operation S1120—Yes), the second processor 1050 may determine whether the obtained identification information is registered identification information (operation S1140). The second processor 1050 may determine whether the obtained identification information is registered identification information by comparing the obtained identification information with identification information stored in the storage unit 1020. FIG. 19 is a reference diagram showing examples of identification information and an authentication element according to an embodiment. As shown in FIG. 19, one or more identification information may be stored in the storage unit 1020 binarily. When the same identification information as the obtained identification information is stored in the storage unit 1020, the second processor 1050 may determine that the obtained identification information is registered identification information.

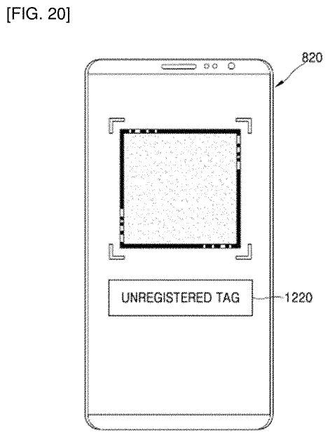

However, when it is determined that the obtained identification information is not registered identification information (operation S1140—No), the second processor 1050 may generate a second indicator indicating that the tag is unregistered, and the output unit 1030 may output the second indicator (operation S1150). FIG. 20 is a diagram showing an example of outputting a second indicator 1220 according to an embodiment. As shown in FIG. 20, the second indicator 1220 may be displayed as a text on a display.

When identification information is not recognized or recognized identification information is not registered, authenticity verification may not be performed. Therefore, the second processor 1050 may output an indicator of the same type as the second indicator 1220 indicating that confirmation failed. However, a tag including unregistered identification information may be a tag similar to an authenticity verification tag according to an embodiment and may be a fake tag. To prevent the distribution of fake tags, a first indicator and a second indicator may be output differently.

When it is determined that the identification information is registered identification information (operation S1140—Yes), the second processor 1050 may obtain information regarding an authentication element corresponding to the identification information (operation S1160). The second processor 1050 may obtain information regarding an authentication element corresponding to identification information by using metadata stored in the storage unit 1020. Information regarding an authentication element may include at least one of a shape, a size, a color, a location in the second region 130, and a density of the authentication element. As shown in FIG. 19, information regarding the authentication element may be matched to each corresponding identification information. Location information regarding the authentication element may be displayed as information regarding coordinates in the second region 130. Also, information regarding the shape and the color of the authentication element may be stored. Although FIG. 19 shows that information regarding an authentication element is stored as a text, the present disclosure is not limited thereto. Information regarding an authentication element may be stored as an image itself.

The second processor 1050 may check whether an authentication element exists (operation S1170).

The plurality of spots 140 that may be used for authenticity verification may be disposed in the second region 130. The spots 140 may be arranged in the second region 130 and be apart from one another. Each of the spots 140 may be any one of special characters, letters, and numbers. The letters may be letters of languages, such as Korean, Japanese, and Chinese, other than English letters, and special characters, and numbers.

The size of each spots 140 may be a visually unrecognizable size. For example, the spots 140 may have a thickness t of about 0.02 mm or less. Alternatively, the spots 140 may have a length l or a width w of about 0.10 mm or less, and an interval between the spots 140 may be about 0.15 mm.

Meanwhile, at least one of sizes, shapes, arrangement directions, and colors of the spots 140 adjacent to one another from among the plurality of spots 140 may differ. As the spots 140 of different types are randomly arranged as described above, the spots 140 may not be visually identified, but the spots 140 may be visually seen as being separated from one another.

The spots 140 may also be used for authenticity verification. Spots arranged at locations corresponding to the location information regarding an authentication element stored in the storage unit 1020 may be used for authentication verification. In detail, the second processor 1050 may recognize spots arranged at a location of the second region 130 corresponding to the location information stored in the storage unit 1020 and may determine whether recognized spots coincide with information regarding an authentication element. In other words, the second processor 1050 may determine whether a shape, a size, a color, or an arrangement direction of the spots is identical to that in the information regarding an authentication element. When a spot coinciding the information regarding an authentication element exists at a pre-registered location of the second region 130, the second processor 1050 may determine that the authentication element exists.

Although the above descriptions are given based on one authentication element, the present disclosure is not limited thereto. There may be a plurality of authentication elements, and the existence of authentication elements may be determined by comparing the consistency between the spots 140 and the authentication elements on the probability basis and then comparing a result thereof with a reference value. Alternatively, the existence of authentication elements may be determined by comparing the density of the spots 140 (that is, authentication elements) having a particular shape or the spots 140 (that is, authentication elements) having a particular color in the second region 130 with a reference value.

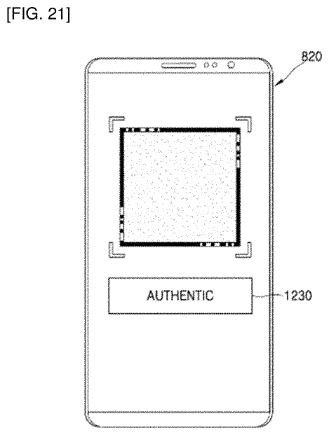

When it is determined that authentication elements exist (operation S1170—Yes), the second processor 1050 may generate a third indicator indicating that the tag is authentic and output the third indicator through the output unit 1030 (operation S1180). The third indicator may be shown on a display in the form of an icon. FIG. 21 is a reference diagram showing an example of a third indicator 1230 indicating that a tag is authentic according to an embodiment. A user may see the third indicator 1230 and be sure that a tag is authentic and a product associated with the tag is authentic.

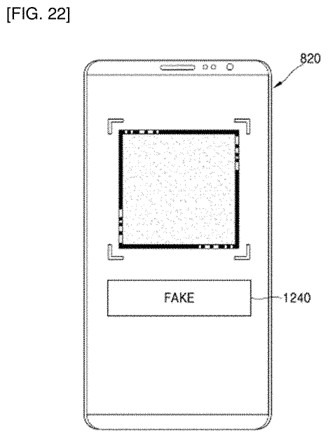

When it is determined that no authentication element exists (operation S1170—No), the second processor 1050 may output a fourth indicator indicating that the is not authentic (operation S1190). The fourth indicator may also be displayed on the display in the form of an icon. FIG. 22 is a reference diagram showing an example of a fourth indicator indicating that a tag is not authentic according to an embodiment. A user may see a fourth indicator 1240 and be sure that a tag is fake and a product associated with the tag is also a fake.

The system 800 according to an embodiment may provide various information by using a result of executing an authenticity verification application. Every time the user terminal 820 executes an authenticity verification application and outputs an indicator, the user terminal 820 may transmit a result thereof to the management server 810.

For example, in case of outputting a first indicator indicating that a tag is not recognized, the user terminal 820 may transmit a photograph of a tag together with the first indicator to the management server 810. The management server 810 may store the first indicator and the photograph of the tag in the form of metadata. Alternatively, the management server 810 may check whether the failure of recognition is due to a malfunction of the authenticity verification application while the tag is a recognizable tag. Then, a result of the checking may be used as data for improving the performance of the application.

Even when outputting a second indicator indicating that the tag is an unregistered rag, the user terminal 820 may transmit a photograph of the tag together with the second indicator to the management server 810. The fact that the second indicator is output indicates that identification information is obtained from the tag. However, when the obtained identification information is unregistered identification information, it is likely that the photographed tag is a fake tag. Therefore, the user terminal 820 transmits the photograph of the tag to the management server 810, such that the management server 810 may manage fake tags. The user terminal 820 may transmit not only the photograph of the tag, but also location information thereof to the management server 810. Then, an administrator may double-check whether the tag is a fake tag and take an action to prevent the occurrence of fake tags.

When a third indicator indicating that the tag is authentic is output, the user terminal 820 may transmit location information regarding the tag together with a result thereof to the management server 810. The management server 810 may store the third indicator and the location information in the form of metadata and use the above information to statisticize the distribution path of a product associated with the tag. Alternatively, the user terminal 820 may transmit information regarding the user terminal 820 as well as information regarding the third indicator to the management server 810. Since the user terminal 820 is a terminal that has downloaded the authenticity verification application from the management server 810, the management server 810 may obtain information regarding a user of the user terminal 820 based on information regarding the user terminal 820. Therefore, the management server 810 may also statisticize information regarding consumers of a product associated with the tag.

When a fourth indicator indicating that the tag is not authentic is output, the user terminal 820 may transmit location information regarding the tag together with a result thereof to the management server 810. The fact that the fourth indicator is output may highly likely indicate that the photographed tag is a fake tag. The management server 810 may store the fourth indicator and the location information in the form of metadata and use the above information to statisticize the distribution path of a product associated with the tag. The administrator may double-check whether the tag is a fake tag and take an action to prevent the occurrence of fake tags.

Example embodiments of an authenticity verification tag have been described and illustrated in the accompanying drawings in order to facilitate understanding of the present disclosure. However, it should be understood that such embodiments are merely illustrative of the present disclosure and do not limit it. It is also to be understood that the present disclosure is not limited to the illustrations and the descriptions given above. This is because various other modifications may be made by one of ordinary skill in the art.

### EXPLANATION OF REFERENCE NUMERALS DESIGNATING THE MAJOR ELEMENTS OF THE DRAWINGS

100: authenticity verification tag
110; layer
120: first region
130: second region
140: spots
200: identification information
200a: first unit element
200b: second unit element
400: copy-proof elements
800: system
810: management server
820: user terminal

What is claimed is:

1. An authenticity verification tag comprising:
a layer;
a first region, which forms a border on the layer and comprises identification information regarding a product to be verified for authenticity;
a second region surrounded by the first region; and
a plurality of spots, which are arranged in the second region and are usable for authenticity verification.

2. The authenticity verification tag of claim 1, wherein the plurality of spots is spaced apart from one another.

3. The authenticity verification tag of claim 1, wherein each of the plurality of spots is one of special characters, letters, and numbers.

4. The authenticity verification tag of claim 1, wherein neighboring spots among the plurality of spots are different to each other in at least one of size, shape, arrangement direction, and color.

5. The authenticity verification tag of claim 1, wherein at least one of the plurality of spots has a length of 0.10 mm or less.

6. The authenticity verification tag of claim 1, wherein the plurality of spots comprises:
authentication elements used for the authenticity verification; and
camouflage elements not related to the authenticity verification.

7. The authenticity verification tag of claim 6, wherein at least one of a location in the second region, a density, a color, and a shape of the authentication element is pre-defined.

8. The authenticity verification tag of claim 6, wherein the authentication element comprises a separate color.

9. The authenticity verification tag of claim 1, wherein a plurality of copy-proof elements, which are arranged in the second region and indicate that the authenticity verification tag is fabricated in a manner different from a pre-defined manner.

10. The authenticity verification tag of claim 9, wherein neighboring copy-proof elements among the plurality of copy-proof elements are same in at least one of size, shape, arrangement direction, and color.

11. The authenticity verification tag of claim 1, wherein the plurality of copy-proof elements are larger than the plurality of spots.

12. The authenticity verification tag of claim 1, wherein the interval between the plurality of copy-proof elements is smaller than the interval between the plurality of spots.

13. The authenticity verification tag of claim 1, wherein the first region is formed by 1-dimensionally arranging first unit elements having a first color and second unit elements having a second color different from the first color.

14. The authenticity verification tag of claim 1, wherein the identification information is indicated by a combination of first unit elements and second unit elements that are arranged at a certain distance from the first unit element.

15. The authenticity verification tag of claim 14, wherein the identification information comprises at least one of information regarding a manufacturer providing the product, brand information regarding the product, and detailed information regarding the product.

16. The authenticity verification tag of claim 1, wherein the second region includes at least one of an image and text related to the product.

17. The authenticity verification tag of claim 16, wherein at least one of the image and the text is arranged to overlap the spots.

18. The authenticity verification tag of claim 16, wherein at least one of the image and the text is larger than a size of at least one of the spots.

19. The authenticity verification tag of claim 18, wherein at least one of the image and the text is at least 10 times larger than the size of at least one of the spots.

20. A wrapping paper comprising an authenticity verification tag according to any one of claims 1 to 19.
